(19) United States
(12) Patent Application Publication
(10) Pub. No.: US 2015/0193172 A1
(43) Pub. Date: Jul. 9, 2015

(54) WEARABLE DATA STORAGE AND CACHING

(71) Applicant: Imation Corp., Oakdale, MN (US)

(72) Inventors: Toshihide Hokari, Woodbury, MN (US); Alan Olson, Cottage Grove, MN (US); Blake A. Verdon, St. Paul, MN (US)

(21) Appl. No.: 14/589,173

(22) Filed: Jan. 5, 2015

Related U.S. Application Data
(60) Provisional application No. 61/923,899, filed on Jan. 6, 2014.

(51) Int. Cl. G06F 3/06

(52) U.S. Cl. CPC G06F 3/0655; G06F 3/0604; G06F 3/0673

(57) ABSTRACT

Embodiments of the invention include a caching device for temporary storage of content generated using a content-generating device. The caching device and the content-generating device can be operatively coupled. The caching device can be worn on a user's body. The caching device includes a housing, a power source supported by the housing, a storage device adapted to store content, and an antenna supported by the housing. The antenna can transmit or receive content from/to the storage device to/from a content-generating device. The caching device can consume low power and can transfer content at low data rates.

### RELATED APPLICATIONS

The present application claims priority to U.S. provisional application No. 61/923,899, the entire contents of which are incorporated herein by reference.

### FIELD

This disclosure relates to devices and methods for wearable data storage, caching and transmission.

### BACKGROUND

Portable and wearable devices allow users to generate data. Such devices can include smartphones, digital voice recording devices, wearable photo and video cameras, tablets and the like. A user may use the portable device to generate photographs, video or audio recordings and similar data, referred to collectively as “content” herein. Portable and wearable devices often have limited onboard memory or data storage capacity, as a result of which, a user may have to limit content generation. For instance, a device may limit content generation (e.g., recording) to a predetermined level (e.g., 2-4 hours of continuous recording). The user may then transfer the generated content to a storage device to release more memory or storage capacity for further content generation.

Often, a cloud-based storage solution can be coupled to portable or wearable devices. Such solutions often include the ability to transmit content to a remote storage facility via wireless signals (e.g., WiFi, cellular data network such as 4G, etc.) while content is being generated by the portable device. Such cloud-based storage solutions may offer much higher storage capacity than that available onboard the portable device. The cloud-based solutions, however, incur a cost per quantity (e.g., cost per gigabyte) of content stored after a certain amount of free storage, as well as a cost for data transmission when utilizing the cellular data network. Additionally, a user may use the portable device at remote locations with limited ability to transmit or receive content via wireless signals to/from a cloud storage facility. Such transmission or reception may have “bottlenecks” due to the limited rate of content transfer.

Improved systems for content management are therefore desired.

### SUMMARY

Various embodiments include wearable or portable content storage that can provide lower cost and greater ease of content transfer. Embodiments of the invention include a caching device. The caching device may include a housing, a power source supported by the housing, a storage device adapted to store content and an antenna supported by the housing. The antenna can be adapted to transmit or receive content from/to the storage device to/from a content-generating device. The caching device can be operatively coupled to the content-generating device. The caching device can include a fastener or a lanyard. The fastener or lanyard can allow a user to operatively couple the caching device to the user's body.

In some embodiments, the caching device consume power up to about 20 Watts. In some embodiments, the caching device consumes a power at up to about 1000 milliWatts, or up to about 500 milliWatts, or up to about 350 milliWatts. For instance, the power consumption of the caching device can be approximately 332.5 milliWatts. In some embodiments, the caching device can transmit content up to a distance of approximately 100 meters, or approximately 50 meters, or approximately 10 meters. For instance, the caching device can transmit content up to a distance of approximately 10 meters. In some embodiments, the content transmission occurs at the data rate of up to approximately 1300 Megabits per second. In some embodiments, the content transmission occurs at the data rate of up to approximately 450 Megabits per second. In some embodiments, the content transmission occurs at the data rate of up to approximately 50 Megabits per second. In other embodiments, the data rate can be up to approximately 3 Megabits per second. In some embodiments, the antenna is adapted to transmit or receive content from/to the storage device via Bluetooth communication protocol.

### BRIEF DESCRIPTION OF THE DRAWINGS

The following drawings are illustrative of particular embodiments of the present invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 illustrates a user generating content using a content-generating device;

FIG. 2 is an illustration of the caching device according to some embodiments of the invention, worn on a user's body;

FIG. 3 is a perspective view of the caching device of FIG. 2;

FIG. 4 is a sectional front view of the caching device of FIG. 3; and

FIG. 5 is a schematic of various operations performed by the caching device.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Embodiments of the invention include a wearable caching device for caching content generated by a portable content-generating device. Such caching devices can be used to cache content generated by portable and/or wearable content-generating devices such as smartphones, digital voice recorders, wearable photo and video cameras (e.g., a camera that a user may wear on a portion of their body to record images, audio and video content), portable ‘smart’ watches (e.g., a watch with a touch-sensitive display adapted to record images, audio and video content that a user may wear on their wrist), tablet devices and the like. For instance, the content generating device 20 may be camera coupled to eye-glasses. The content generating device 20 may be a high-definition camera that can capture fast-moving events such as sports events (e.g., surfing, snowboarding, scuba-diving events, etc.). The content generating device 20 may be waterproof to approximately 200 feet below sea level to allow underwater content-generation 20. The content generating device 20 may include a rugged construction and universally connectable fasteners to couple them to any surface, including a user's body and uneven surfaces such as exterior of an airplane, ski poles, vehicle hoods, surfboards, boats and the like.

The term “content” as referred to herein could include text, image, audio, video and similar forms of data. Users may generate content using the portable content-generating device such as a hand held device. The term “wearable” as used herein may refer to a device that can be worn by a user on a part of their body directly or indirectly (e.g., by way of clips, hooks, mounts, bands, straps, frames, helmets, etc.). For instance, a user 10 may wear a content generating device 20 such as a head-mounted camera to record video as the user 10 encounters or moves through their surroundings. In other embodiments, the user 10 may wear the content generating device 20 on their wrist or waist, or couple it to clothing or accessories worn while playing sports (e.g., a ski pole).

When the user 10 generates large quantities (e.g., a few hundred megabytes, representative of tens of minutes of video, audio recording lasting a few hours, etc.) of content using content-generating devices 20, the content may have to be transferred out of the content-generating devices 20, as they often have limited onboard memory to store large quantities of content that are generated by the user 10. Embodiments of the invention can allow the content generated by the content-generating device 20 to be temporarily stored (e.g., cached) on a caching device 100 while the user 10 is generating content with the content-generating device 20. The user 10 may continue caching content on the caching device 100 even after the content generation is complete. In some embodiments, the content-generating device 20 can cache the content first temporarily in the on-board memory of the content-generating device 20 before transmitting the content to the caching device 100 for caching or storage. In such embodiments, the content-generating device 20 can retrieve the content from the caching device 100 for playback. While retrieving it, the content-generating device 20 can cache portions of the content (or the entire content) in its on-board memory to allow seamless playback. In such a manner, embodiments of the invention may allow for continuous/uninterrupted content generation. For instance, the user 10 may not have to stop generating content to complete the transfer of content. Such embodiments can allow seamless content generation and low-cost, ease of caching.

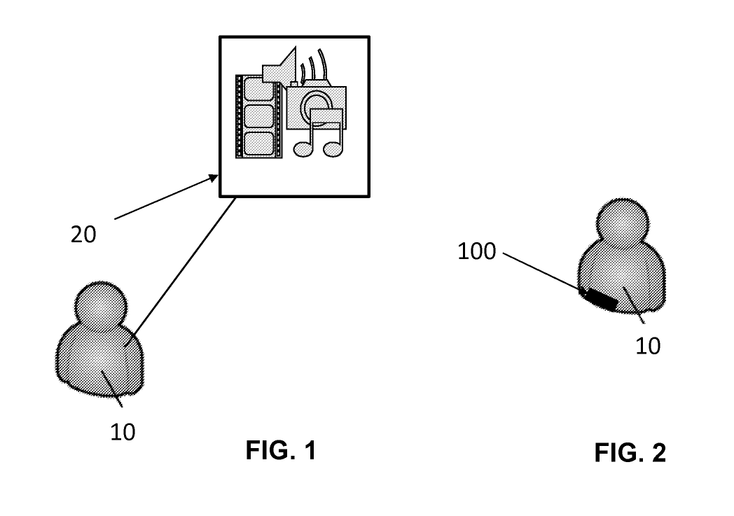

FIG. 2 shows an embodiment of the caching device 100 worn by a user 10 on the user's body. In other embodiments not illustrated, the caching device 100 may be mounted on a mounting surface (e.g., a desk, dashboard of a vehicle, etc.). In alternate embodiments, the caching device 100 can be mechanically coupled to the content-generating device 20 directly. In some embodiments, the caching device 100 may be housed in a portion of a housing of the content-generation device 10. In some embodiments, a user 10 may wear both the content-generating device 20 and the caching device 100 on the user's body (such as the illustrated embodiments in FIGS. 1 and 2). Alternatively, the user 10 may carry the caching device 100 with him or her in a pocket, purse or by hand, for example. In some embodiments, the caching device 100 and/or the content-generating device 20 may be stored in a sleeve, a jacket or a similar cover. In such embodiments, the cover (and the caching device 100 and/or the content-generating device 20 stored therein) may be coupled to the user's body. In some embodiments, the caching device 100 may be coupled to uneven surfaces such as exterior of an airplane, ski poles, vehicle hoods, surfboards, boats and the like. Such embodiments can allow hands-free content-generation and caching as content is generated by the user on the go. In other embodiments, the user 10 may wear either or none of the content-generating device 20 and the caching device 100. In such embodiments, the caching device 100 may be positioned away (e.g., approximately within 10 meters) from the content-generating device 20.

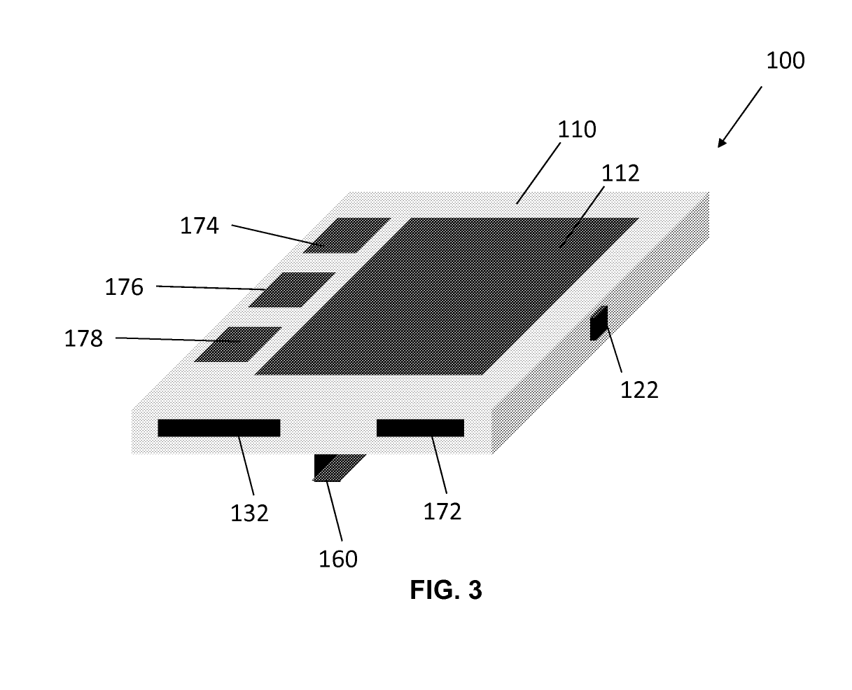

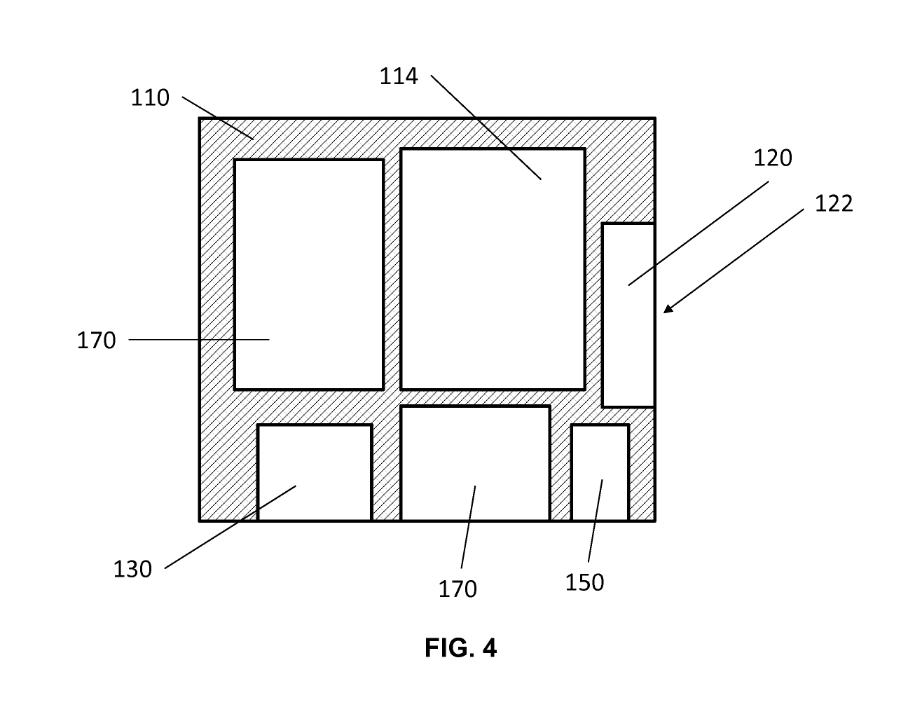

Referring now to FIGS. 3-4, the content-generating device 20 can include a housing 110. The housing 110 can be made of a rugged and durable material (e.g., synthetic polymers) to allow for operation under extreme conditions. For instance, the housing 110 can be durable to shock and crushing loads, drop proof to several thousand feet, operable up to a few hundred feet under water, and capable of withstanding extreme temperature differences of a hundred degree Celsius. The housing 110 can include a display 112 to show status of content transfer. The housing 110 can be made of a rigid material such as metal or rigid plastic. The housing 110 can support any of the components of the caching device 100. For example, the housing 110 can include one or more of port 122 or slot 132, and a plurality of buttons 172, 174, 176, 178. The housing 110 can include a fastener 160. The port 122, slot 132, buttons 172, 174, 176, 178 and fastener 160 will be described subsequently herein. The housing 110 can support internal circuitry 114 for delivering electrical power and signals to the display 112 and various other components of the caching device 100.

The housing 110 can support a power source 120. In some embodiments, the power source 120 may include rechargeable battery cells (e.g., batteries made of Lithium Ion, Lithium Polymer, Nickel Metal Hydride or similar materials). The battery can be charged via a charging port 122. In some embodiments, the charging port 122 can be a Universal Serial Bus (USB) port. The charging port 122 may connect to an electrical outlet to supply electrical power to the power source 120. Other charging ports (e.g., a proprietary charging port) can also be used and the specific type of charging port does not limit the scope and applicability of the caching device 100. In some embodiments, the caching device 100 consumes electrical power of up to approximately 20 Watts. In other embodiments, the caching device 100 consume electrical power of up to approximately 20 Watts, or approximately 1000 milliWatts, or approximately 500 milliWatts or approximately 350 milliWatts. In some embodiments, the caching device 100 consumes electrical power of approximately 332.5 milliWatts. In such embodiments, the power source 120 can provide power to the caching device 100 for a duration in the range between approximately 6 hours and approximately 8 hours, such as when used for transmission via Bluetooth. For example, if the user 10 generates a video approximately 1 hour in duration, the video may need approximately 4 gigabytes of storage. In such embodiments, the content transfer can occur at a data rate of approximately 3 Megabits per second. In other words, it may take approximately 3 hours for content to be transfer to the caching device 100. In such embodiments, the power source 120 can provide power to the caching device 100 for the entire duration of content transfer. The power source 120 may continue providing power to the caching device 100 for many hours even after content has been transferred from the content generating device 20 to the caching device 100.

For example, in some embodiments the caching device 100 may transmit and/or receive data using Wifi and may consume electrical power at up to approximately 20 Watts with a data transfer rate of up to approximately 1300 Megabits per second and to distances of up to approximately 100 meters, 50 meters, or 10 meters. In other embodiments, the caching device 100 may transmit and/or receive data using Bluetooth and may consume electrical power at up to approximately 500 milliWatts with a data transfer rate of up to approximately 3 Megabits per second to a distance of up to approximately 10 meters.

The housing 110 can include a storage device 130 adapted to store content. For instance, the housing 110 can include a slot 132 into which the storage device 130 (e.g., a removable storage device such as a memory card) can be inserted. The storage device 130 can include predetermined memory storage capability (e.g., 64 gigabyte, 128 gigabyte and the like).

The storage device 130 can store the content generated by the content-generating device 20 temporarily. In such embodiments, the charging port 122 of the caching device 100 may be useful for both charging the caching device 100, and operably coupling the caching device 100 to an electronic device (e.g., a laptop or a desktop computer, not shown). The electronic device (not shown) can access the cached content stored on the storage device 130. Content can be transferred from the caching device 100 to electronic device. For instance, the charging port 122 can be a USB port and/or a similar connector. A USB cable (not shown) can then be engaged with the charging port 122 to connect the caching device 100 to a laptop or a desktop computer or any other electronic device. Content stored on the caching device 100 can then be transferred to the electronic device.

The content-generating device 20 may access the content stored in the storage device 130. The storage device 130 can be adapted to cache content, so that the content-generating device 20 can seamlessly (e.g., without interruption) access content stored in the storage device 130. The storage device 130 can be a flash-memory based storage device 130 (e.g., SD cards and the like). In some embodiments, the storage device 130 can be a solid-state drive. In other embodiments, the storage device 130 can be a hard disk drive. The storage device 130 can receive power from the power source 120. In such embodiments, the storage device 130 can be adapted to consume low power (e.g., less than 0.5 milliWatts), especially when the caching device 100 does not receive content from or send content to the content-generating device 20.

The caching device 100 includes an antenna 150 supported by the housing 110. The antenna 150 can transmit or receive content from/to the storage device 130 to/from the content-generating device 20. In some embodiments, the antenna 150 can transmit or receive content from/to the storage device 130 via one or more of Bluetooth communication protocol, short-range radio waves, WiFi (e.g., IEEE 802.11ac, 802.11b, 802.11g, 802.11n and similar standards), infrared protocol, cellular communication signals, or satellite communication signals. In some embodiments, the antenna 150 can transmit or receive content from/to the storage device 130 via Bluetooth communication protocol. In such embodiments, the content-generating device 20 includes a Bluetooth adapter configured to communicate with the antenna 150 of the caching device 100. The content-generating device 20 and the caching device 100 may thus form a Personal Area Network (PAN) or a Wireless Personal Area Network (WPAN). In such embodiments, the caching device 100 can transmit or receive content up to a distance of approximately 100 meters, or approximately 50 meters or approximately 10 meters. For instance, the caching device 100 can transmit or receive content up to a distance of approximately 10 meters. Such embodiments can be useful for allowing a user 10 to wear both the content-generating device 20 (e.g., a head-mounted video camera) and the caching device 100 on the user's body.

In a non-limiting exemplary embodiment, the caching device 100 may include a fastener 160 that allows the user 10 to wear the caching device 100 on the user's body. The fastener 160 can be a mechanical fastener 160 (e.g., a clip, a latch, a hook etc.). In other embodiments, the fastener 160 can be a band or a strap of elastic material that can be worn around the user's body (e.g., around the user's arm, wrist, waist, etc.). The band or strap may include fasteners (e.g., hook and loop fasteners, buckles etc.) to allow the user 10 to wear the caching device 100 on the user's body. Such embodiments can allow hands free operation and allow the user 10 to generate content while wearing the device (e.g., recording a teleconference, recording pictures or videos while a user 10 is running or riding a bicycle, or when the user 10 is driving a vehicle).

In a non-limiting exemplary embodiment, the user 10 may not simultaneously consume content (e.g., view a live feed of a video recording) while the content is being generated. In such embodiments, the content transfer from the content-generating device 20 to the caching device 100 can occur at data rates of up to approximately 1300 Megabits per second. In some embodiments, the content transfer from the content-generating device 20 to the caching device 100 can occur at data rates of up to approximately 450 Megabits per second. In some embodiments, content transfer from the content-generating device 20 to the caching device 100 can occur at up to approximately 50 Megabits per second. In some embodiments, content transfer from the content-generating device 20 to the caching device 100 can occur up to approximately 3 Megabits per second. In some embodiments, the data rates can be approximately 3 Megabits per second. Such data rates can allow for lower power consumption by the caching device 100 than devices that transfer content at data rates larger than 25 Megabits per second.

In some embodiments, the caching device 100 and the content-generating device 20 can communicate via Bluetooth 2.0+EDR communication standard. In some embodiments, the caching device 100 and the content-generating device 20 can communicate via Bluetooth 2.1+EDR communication standard. In some embodiments, the caching device 100 and the content-generating device 20 can communicate via Bluetooth 3.0+EDR communication standard. In some embodiments, the caching device 100 and the content-generating device 20 can communicate via Bluetooth 4.0+EDR communication standard. Any further improved Bluetooth communication standards beyond Bluetooth 4.0+EDR can also be used without any loss of scope or applicability of the device. In some embodiments, the caching device 100 and the content-generating device 20 can communicate via WiFi communication (e.g., 802.11ac, 802.11n, 802.11g and higher) standard.

The caching device 100 can include a controller 170 supported by the housing 110. The controller 170 can receive signals from the content-generating device 20. The controller 170 can perform, upon receipt of signals from the content-generating device 20, one or more of the following: (a) recognize device properties of the content-generating device 20 via Bluetooth communication protocol; (b) connect with the content-generating device 20 via Bluetooth communication protocol; (c) start content transmission between the caching device 100 and the content-generating device 20; and (d) stop content transmission between the caching device 100 and the content-generating device 20. The controller may also perform other functions necessary for the operation of the caching device 100 including (a) recording content on the storage device 130; (b) retrieving content from the storage device 130; and (c) erasing content on the storage device 130. The caching device 100 can include one or more buttons, such as a plurality of buttons 172, 174, 176, 178 positioned on the housing 110. The buttons 172, 174, 176, 178 can actuate the controller 170 to perform any of the controller's operations. In some embodiments, the controller 170 can send a signal to the content-generating device 20 to alert the user 10 that content transfer (e.g., caching) has been completed. The controller 170 can send a signal that requires a user 10 input. For instance, the controller 170 can request the user 10 to indicate whether the user 10 wishes to retain the content on the content-generating device 20. The user 10 may actuate a button to delete the content from the content-generating device 20.

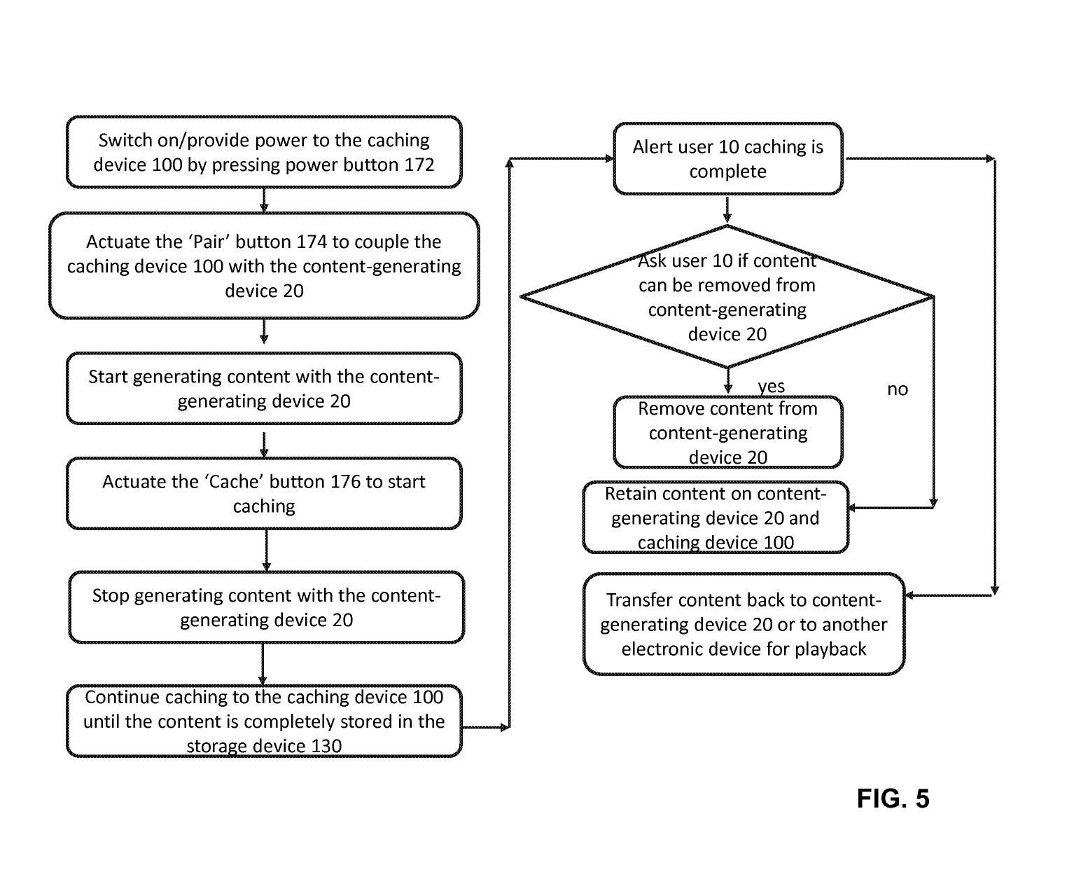

In some embodiments, the caching device 100 continues to transmit content to or receive content from the content-generating device 20 while the content-generating device 20 generates content. As seen in FIG. 5, the caching device 100 can first be powered on by actuating the power button 172. The caching device 100 can then be operatively coupled with the content-generating device 20 (e.g., by Bluetooth “pairing”) by pressing a pair button 174. The controller 170 of the caching device 100 can be actuated to begin caching by pressing the cache button 176. The user 10 may then start generating content. The caching device 100 continues the caching operation while the user 10 generates content. In such embodiments, the onboard memory available on the content-generating device 20 does not fill to its maximum capacity. Thus, the user 10 can continue generating more content without any interruption. The user 10 may then stop generating content when desired, and content-generation is not limited by the capacity of the content-generating device's onboard memory or storage capability.

In other embodiments, the content-generating device 20 may cache a portion of the content or the entire content in its limited on-board memory before transmitting the portion of the content or the entire content to the caching device 100. Such embodiments may allow seamless caching so that the user may extend the duration of content-generation beyond the predetermined limits. For instance, if a digital voice recorder is the content-generating device 20 with an onboard memory capable of storing 2-4 hours of recording, then embodiments of the caching device 100 can allow the digital voice recorder to record for many hours beyond 2-4 hours as the recorded content is cached in the content-generating device 20 and transmitted to the caching device 100 for releasing the space available for caching on the onboard memory.

In some embodiments, as seen in FIG. 5, the caching device 100 continues to transmit content to or receive content from the content-generating device 20 after the content-generating device 20 has stopped generating content. As shown in FIG. 5, once the caching device 100 has completed the caching operation (e.g., stopped receiving content from the content-generating device 20), the controller 170 may be actuated to send a message to the content-generating device 20 alerting the user 10 that caching is complete. In some embodiments, the controller 170 may request a user 10 to actuate a delete button 178 to retain content in both the content-generating device 20 and the caching device 100. In such embodiments, the user 10 may actuate the delete button 178 to remove content from the content-generating device 20. The user 10 may also request the caching device 100 to send the content-generating device 20 or another device for playback.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

1. A caching device comprising:
a housing;
a power source supported by the housing;
a storage device adapted to store content; and
an antenna supported by the housing, wherein the antenna is adapted to transmit content from the storage device to a content-generating device, receive content from the content-generating device to the storage device, or both, and wherein the caching device is operatively coupled to the content-generating device, and the caching device consumes a power of up to approximately 20 Watts.

2. The caching device of claim 1, wherein the antenna is adapted to transmit content, or receive content, or both, via a wireless signal.

3. The caching device of claim 1, wherein the antenna is adapted to transmit content, receive content, or both, via one or more of Bluetooth communication protocol, short-range radio waves, WiFi, cellular communication signals, infrared protocol, or satellite communication signals.

4. The caching device of claim 1, wherein the power source can provide power to the caching device for a duration in the range between approximately 6 hours and approximately 8 hours.

5. A caching device comprising:
a housing;
a power source supported by the housing;
a storage device adapted to store content; and
an antenna supported by the housing; wherein the antenna is adapted to transmit content from the storage device, receive content to the receiving device, or both; the content transmitted by the antenna being received by or sent to a content-generating device; the caching device consumes a power of up to approximately 500 milliWatts; and the content transmission occurs at the data rate of up to approximately 3 Megabits per second.

6. A caching device comprising:
a housing;
a power source supported by the housing;
a storage device, adapted to store content;
an antenna supported by the housing; and
a fastener allowing a user to operatively couple the caching device to the user's body, wherein
the antenna is adapted to transmit content from the storage device, receive content to the storage device, or both, via Bluetooth communication protocol, and
the content transmitted by the antenna being received by or sent to a content-generating device.

7. The caching device of claim 6, further comprising a charging port coupled to the housing, the charging port adapted to receive a charger coupled to an electrical outlet, the charging port supplying electrical power to the power source.

8. The caching device of claim 7, wherein the power source is a battery.

9. The caching device of claim 7, wherein the charging port is a Universal Serial Bus port, adapted to connect to an electrical outlet and supply electrical power to the power source.

10. The caching device of claim 9, wherein the charging port can be operably connected to an electronic device to transfer content from the caching device to the electronic device.

11. The caching device of claim 6, further comprising a controller supported by the housing, the controller adapted to receive signals from the content-generating device, the controller adapted to perform, upon receipt of signals from the content-generating device, one or more of:
recognize device properties of the content-generating device via Bluetooth communication protocol;
connect with the content-generating device via Bluetooth communication protocol;
start content transmission between the caching device and the content-generating device;
stop content transmission between the caching device and the content-generating device;
record content on the storage device;
retrieve content from the storage device; and
erase content on the storage device.

12. The caching device of claim 11, further comprising a plurality of buttons positioned on the housing, the buttons adapted to actuate the controller.

13. The caching device of claim 6, wherein the storage device is a flash-memory based storage device.

14. The caching device of claim 6, wherein the storage device is a hard disk drive.

15. The caching device of claim 6, wherein the storage device is a solid-state drive.

16. The caching device of claim 6, wherein the caching device consumes power of up to approximately 332.5 milliWatts.

17. The caching device of claim 6, wherein the caching device transmits or receives content at the data rate of approximately 3 Megabits per second.

18. The caching device of claim 6, wherein the fastener can be further adapted to engage with a mounting surface.

19. The caching device of claim 6, wherein the caching device continues to transmit content to or receive content from the content-generating device while the content-generating device generates content.

20. The caching device of claim 19, wherein the caching device continues to transmit content to or receive content from the content-generating device after the content-generating device has stopped generating content.
